(19) United States
(12) Patent Application Publication
(10) Pub. No.: US 2011/0095660 A1
(43) Pub. Date: Apr. 28, 2011

(54) Bright-Surface Structure and Display with Nut Suspended in Midair

(76) Inventor: Chao-Chun Wang, Fuqing City (CN)

(21) Appl. No.: 12/607,127

(22) Filed: Oct. 28, 2009

(51) Int. Cl. A47B 81/06; F16B 39/00

(52) U.S. Cl. 312/7.2; 411/105

(57) ABSTRACT

A bright-surface structure with nut suspended in midair is provided. The bright-surface structure comprises a main body, at least one nut and at least one holder. The main body has a coupling region and at least one appearance surface with smooth and bright face. The nut is disposed at the side of the coupling region. The holder is disposed between said nut and said main body so that said nut can be firmly disposed on said coupling region by means of said holder. Whereby a screw will not approach said main body or said coupling region so that said appearance surface will not deform or wrinkle when said screw is locked into said nut.

### FIELD OF THE INVENTION

The present invention relates to a bright-surface structure and a display, particularly relates to the bright-surface structure and the display with nut suspended in midair.

### DESCRIPTION OF THE PRIOR ART

Recently, people are pursuing more and more demand on the beauty, especially on the smooth and bright surface which is commonly seen on the appearance of objects. They set higher and higher standard on those objects' appearances. For example, flat panel display, the daily life appliance which presents video with high resolution images needs to be extremely smooth and bright at its front frame and base. The finest appearance on the front frame or on the base not only let user feel pleasure while purchasing the flat panel display but also raise its quality. In this reason, the flat panel display is commonly processed with stoving paint or other treatment which makes appearance surface present smooth and a bright face.

However, even processed with aforementioned treatment, the front frame does inevitably contain wrinkle at its surface because the configuration behind the front frame will squeeze its rear portion. Please refer to FIG. 1, FIG. 1 is diagram of combination of front frame and screw in conventional flat panel display. As shown in FIG. 1, a front frame 9 of a flat panel display (not shown) includes a coupling region 911 and an appearance surface 912. A nut 92 is disposed on the coupling region 911. In order to fasten the front frame 9 to the other components of flat panel display, the configuration, i.e. the screw 95 and the nut 92, are commonly used to combine with those components. However, when the screw 95 is locked into the nut 92, the screw 95 will be tightly fitted with the nut 92 so as to squeeze the base of the nut 92. Thus, the adjacent area around the coupling region 911 and base of the nut 92 will deform and then crumple the appearance surface 912 and generate the wrinkle 96. In the high-end product like flat panel display, the front frame 9 with wrinkle 96 is certainly unacceptable in the viewpoint of beauty. Even though increasing thickness of the front frame 9 may lessen the condition of the wrinkle 96, but, thicker material also means higher cost and worse scenario.

In practice, the wrinkle 96 is not explicit obvious, however in some circumstances, such as projecting light to the flat panel display in a shining exhibition or living room, the wrinkle 96 will be easily seen at its surface and then the beauty and the quality will be degraded.

Except the flat panel display, the product such as kitchen cabinet, cell phone or watch which have put significant amount of energy in their smooth and bright surface may have similar problem. Therefore, to diminish the condition of wrinkle 96 which is resulted from squeeze between the screw 95 and the nut 92 is indeed a serious problem need to be solved.

### SUMMARY OF THE INVENTION

The primary object of present invention is to diminish the wrinkle in the appearance surface, where the wrinkle is resulted from squeeze or deformation of the configuration behind the appearance surface.

To achieve the foregoing and other objects, a bright-surface structure with nut suspended in midair is provided. The bright-surface structure comprises a main body, at least one nut and at least one holder. The main body has a coupling region and at least one appearance surface with smooth and bright face. The nut is disposed at the side of the coupling region. The holder is disposed between said nut and said main body so that said nut can be firmly disposed on said coupling region by means of said holder. Whereby a screw will not approach said main body or said coupling region so that said appearance surface will not deform or wrinkle when said screw is locked into said nut.

To achieve the foregoing and other objects, a display with nut suspended in midair which has a front frame is provided. The front frame comprises a main body, at least one nut and at least one holder. The main body has a coupling region and at least one appearance surface with smooth and bright face. The nut is disposed at the side of the coupling region. The holder is disposed between said nut and said main body so that said nut can be firmly disposed on said coupling region by means of said holder. Whereby a screw will not approach said main body or said coupling region so that said appearance surface of said front frame will not deform or wrinkle and then present smooth and a bright face when said screw is locked into said nut.

In the aforementioned bright-surface structure or display, wherein said holder is a hollow structure.

In the aforementioned bright-surface structure or display, further comprises at least one vibration damper fixing said nut to said coupling region so as to reduce the flexibility of said nut. And, said main body, said nut, said holder and said vibration damper are one-body shaped.

In the aforementioned bright-surface structure or display, wherein said appearance surface is processed with stoving paint, baking enamel, baking varnish, polish, or other treatments which make said appearance surface present smooth and a bright face.

In the aforementioned bright-surface structure or display, wherein said holder includes at least one secondary holder extended from said holder to said nut so as to firmly fix said nut.

In the aforementioned bright-surface structure or display, wherein the amount of said secondary holders are pluralities and said secondary holders are disposed surrounding said nut so as to firmly fix said nut.

In the aforementioned bright-surface structure or display, wherein said holder further includes at least one first support oriented at a first direction to prevent said nut from swinging at said first direction and at least one second support oriented at a second direction to prevent said nut from swinging at said second direction. Said first direction and said second direction are orthogonal to each other.

Whereby, the present invention takes advantage of a specific structure, without increasing the thickness of the main body, to diminish the wrinkle or the deformation resulted from squeeze of the screw. Thus the appearance surface of main body will be kept smooth and bright without crumpling. In this manner, the present invention may be adopted to the product such as kitchen cabinet, watch, cell phone, TV, refrigerator, washing machine, telephone, sheet metal of vehicle, toy, mold, laptop, table, chair, cooker, headlamp of vehicle, stereo, speaker, etc; and then, higher quality is achievable.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is diagram of combination of front frame and screw in conventional flat panel display;

FIG. 2A is diagram of the front frame of the first embodiment in present invention;

FIG. 2B is diagram of combination of front frame and screw of the first embodiment in present invention;

FIG. 3 is diagram of the front frame of the second embodiment in present invention;

FIG. 4 is diagram of the front frame of the third embodiment in present invention;

FIG. 5 is diagram of the front frame of the fourth embodiment in present invention;

FIG. 6 is diagram of the front frame of the fifth embodiment in present invention;

FIG. 7 is diagram of the front frame of the sixth embodiment in present invention.

### DESCRIPTION OF THE PREFERRED EMBODIMENTS

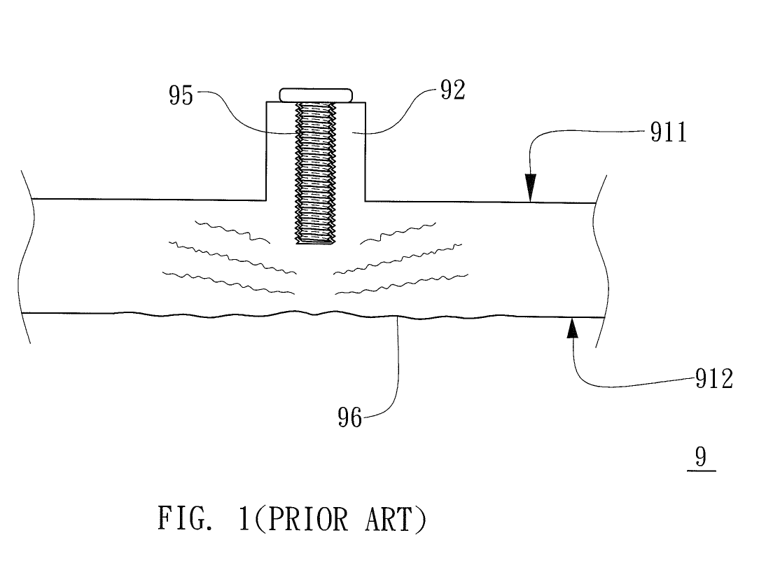

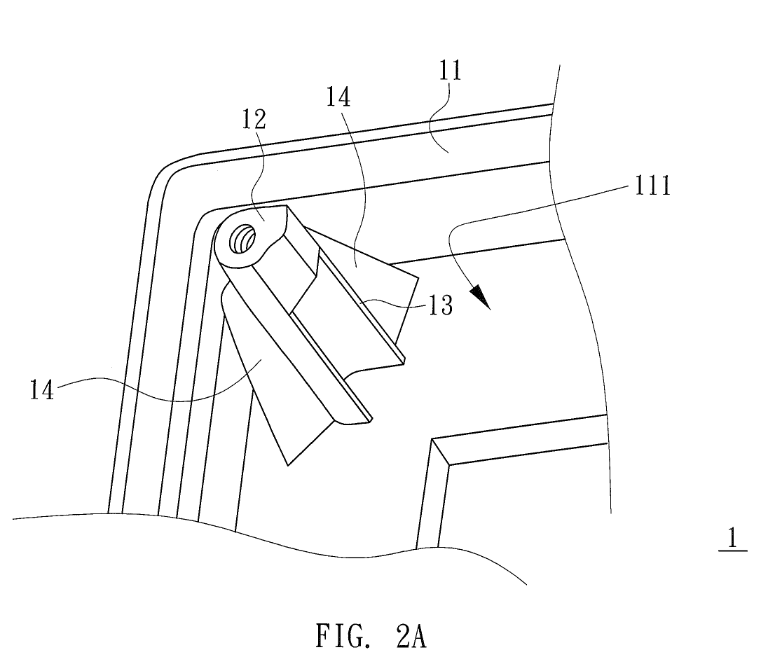

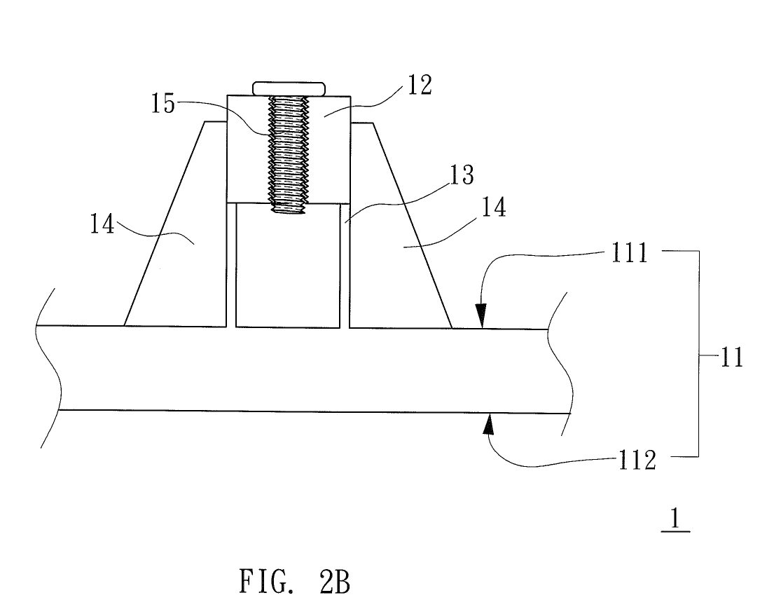

To exemplify the technical features of present invention, an appliance of display in our daily life is introduced and then the benefit will be understood. Please refer to FIG. 2A and FIG. 2B simultaneously. FIG. 2A is diagram of the front frame of the first embodiment in present invention; FIG. 2B is diagram of combination of front frame and screw of the first embodiment in present invention. As shown in these figures, the display (not shown) includes a front frame 1. The front frame 1 contains a main body 11, a nut 12, a holder 13 and two vibration dampers 14 disposed at corner of the front frame 1. The main body 11 comprises a coupling region 111 and a appearance surface 112. The appearance surface 112 is processed with stoving paint, baking enamel, baking varnish, polish, or other treatments which make the appearance surface 112 present smooth and a bright face. The coupling region 111, disposed corresponding to the appearance surface 112, is used to combine with other components of the display and has the nut 12 disposed at the side of the coupling region 111. The holder 13 is a hollow structure which is disposed between the nut 12 and the main body 11 so as to suspend the nut 12 in midair, and then the nut 12 is firmly disposed on the coupling region 111 by means of the holder 13. In this manner, when a screw 15 is locked into the suspended nut 12, the screw 15 will not approach the main body 11 or the coupling region 111 so that the appearance surface 112 of the front frame 1 will not deform or wrinkle. The appearance surface 112 then can be kept smooth and bright and will not squeeze as shown in FIG. 1. Besides, two vibration dampers 14 fix the nut 12 to the coupling region 111 so as to reduce the flexibility of the nut 12 and prevent the nut 12 from swinging.

Furthermore, the main body 11, the nut 12, the holder 13 and the vibration damper 14 may be one-body shaped.

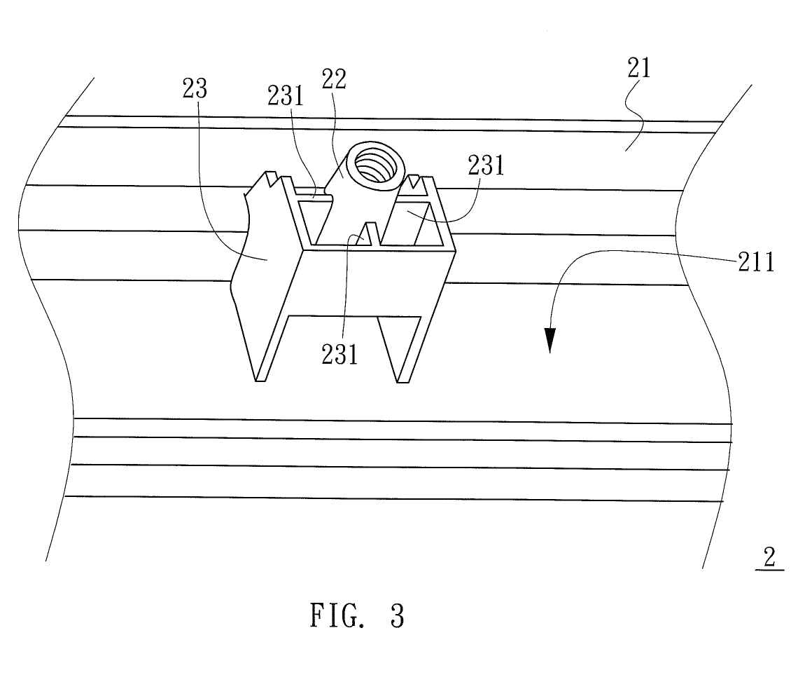

Next, some other embodiments of the display with nut suspended in midair are introduced. Please refer to FIG. 3, FIG. 3 is diagram of the front frame of the second embodiment in present invention. As shown in FIG. 3, the front frame 2 includes a main body 21, a nut 22 and a holder 23. The main body 21 contains a coupling region 211 used to combine with other components of the display (not shown). The nut 22 is firmly disposed on the coupling region 211 and suspended in midair by means of the holder 23. Above the holder 23, three secondary holders 231 are further included to extend from the holder 23 to the nut 22 so that the secondary holders 231 are disposed surrounding the nut 22 and the nut 22 is firmly fixed. In this manner, when the front frame 2 is combined with other components of the display, the circumstance of squeeze or deformation inside the main body 21 is happened no more. Thus the display with nut suspend in midair will have aforementioned benefit.

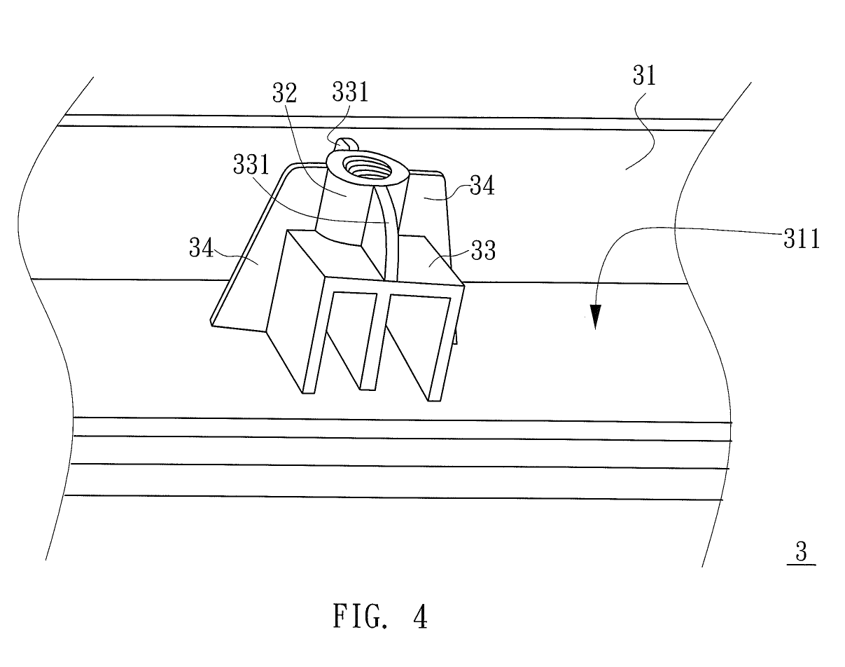

Except that, those ordinary skilled in the art may combine the technical feature of the vibration damper and the secondary holder. Please refer to FIG. 4, FIG. 4 is diagram of the front frame of the third embodiment in present invention. As shown in FIG. 4, the front frame 3 includes a main body 31, a nut 32, a holder 33 and two vibration dampers 34. The main body 31 contains a coupling region 311. The holder 33 is disposed between the nut 32 and the coupling region 311. In this case, the holder 33 further contains two secondary holders 331 above, extended from the holder 33 to the nut 32, so as to fix the nut 32. Beside the nut 32, two vibration dampers 34 are further included. The vibration dampers 34 fix the nut 32 to the coupling region 311 so as to prevent the nut 32 from swinging. Therefore, the display with nut suspended in midair will have aforementioned benefit.

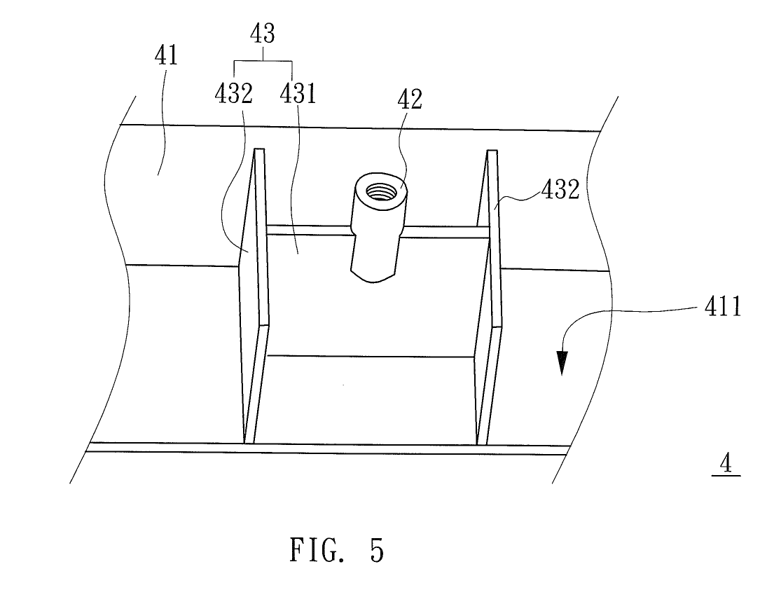

Moreover, the other embodiments are further described. Please refer to FIG. 5, FIG. 5 is diagram of the front frame of the fourth embodiment in present invention. As shown in FIG. 5, the front frame 4 includes a main body 41, a nut 42 and a holder 43. The holder 43 is disposed between the nut 42 and the coupling region 411 of main body 41 so as to suspend the nut 42 in midair. The holder 43 further includes a first support 431 oriented horizontally to prevent the nut 42 from swinging at horizontal direction and two second supports 432 oriented vertically to prevent the nut 42 from swinging at vertical direction. In this case, the direction of the first support 431 is orthogonal to the direction of the second support 432.

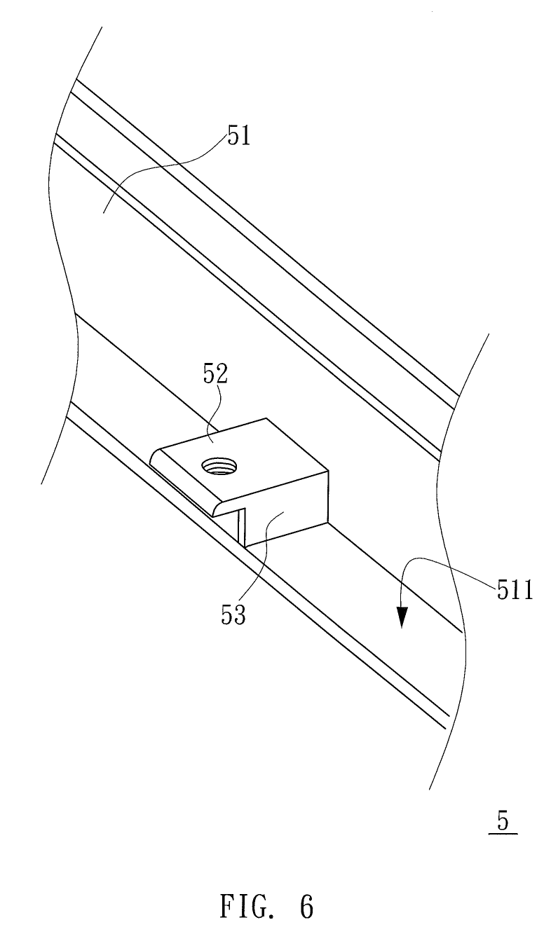

Please refer to FIG. 6, FIG. 6 is diagram of the front frame of the fifth embodiment in present invention. As shown in FIG. 6, the front frame 5 includes a main body 51, a nut 52 and a holder 53. The main body 51 contains a coupling region 511. The holder 53 is disposed between the nut 52 and the coupling region 511 of main body 51 so as to suspend the nut 52 in midair and firmly fix the nut 52 to the coupling region 511 by means of the holder 53. In this manner, the display with nut suspended in midair will have aforementioned benefit.

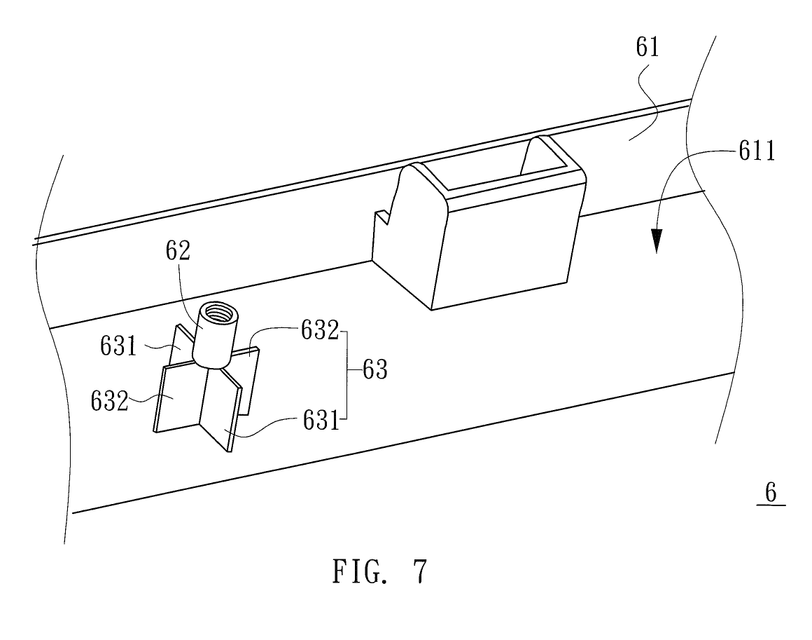

Please refer to FIG. 7, FIG. 7 is diagram of the front frame of the sixth embodiment in present invention. As shown in FIG. 7, the front frame 6 includes a main body 61, a nut 62 and a holder 63. The holder 63 is disposed between the nut 62 and the coupling region 611 so as to suspend the nut 62 in midair. The holder 63 is composed of two first supports 631 and two second supports 632. The first supports 631 and the second supports 632 are disposed orthogonally so as to prevent the nut 62 from swinging in horizontal or vertical direction.

The aforementioned embodiments have been exemplified and described by means of the cases of display; however, the technical feature, bright-surface structure with nut suspended in midair, shall have a broader scope as to be applied in many products such as kitchen cabinet, watch, cell phone, TV, refrigerator, washing machine, telephone, sheet metal of vehicle, toy, mold, laptop, table, chair, cooker, headlamp of vehicle, stereo, speaker, etc. Thus, the present invention is not intended to limit the embodiments presented, but is to be accorded the widest scope consistent with the principles and novel features disclosed herein.

Summarily, the present invention takes advantage of a specific structure, without increasing the thickness of the main body, to diminish the wrinkle or the deformation resulted from squeeze of the screw. Thus the appearance surface of main body will be kept smooth and bright without crumpling. Therefore, the product which adopts the bright-surface structure with nut suspended in midair may achieve beauty in the appearance surface and have higher quality.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

I claim:

1. A bright-surface structure with nut suspended in midair, comprising:
a main body having a coupling region and at least one appearance surface with smooth and bright face;
at least one nut disposed at the side of the coupling region;
at least one holder disposed between said nut and said main body so that said nut can be firmly disposed on said coupling region by means of said holder;
whereby a screw will not approach said main body or said coupling region so that said appearance surface will not deform or wrinkle when said screw is locked into said nut.

2. The bright-surface structure with nut suspended in midair as claim 1, wherein said holder is a hollow structure.

3. The bright-surface structure with nut suspended in midair as claim 1, further comprising at least one vibration damper fixing said nut to said coupling region so as to reduce the flexibility of said nut.

4. The bright-surface structure with nut suspended in midair as claim 3, wherein said main body, said nut, said holder and said vibration damper are one-body shaped.

5. The bright-surface structure with nut suspended in midair as claim 1, wherein said appearance surface is processed with stoving paint, baking enamel, baking varnish, polish, or other treatments which make said appearance surface present smooth and a bright face.

6. The bright-surface structure with nut suspended in midair as claim 1, wherein said holder includes at least one secondary holder extended from said holder to said nut so as to firmly fix said nut.

7. The bright-surface structure with nut suspended in midair as claim 6, wherein the amount of said secondary holders are pluralities and said secondary holders are disposed surrounding said nut so as to firmly fix said nut.

8. The bright-surface structure with nut suspended in midair as claim 1, wherein said holder further includes at least one first support oriented at a first direction to prevent said nut from swinging at said first direction and at least one second support oriented at a second direction to prevent said nut from swinging at said second direction.

9. The bright-surface structure with nut suspended in midair as claim 8, wherein said first direction and said second direction are orthogonal to each other.

10. A display with nut suspended in midair which has a front frame and said front frame comprises:
a main body having a coupling region and at least one appearance surface with smooth and bright face;
at least one nut disposed at the side of the coupling region;
at least one holder disposed between said nut and said main body so that said nut can be firmly disposed on said coupling region by means of said holder;
whereby a screw will not approach said main body or said coupling region so that said appearance surface of said front frame will not deform or wrinkle and then present smooth and a bright face when said screw is locked into said nut.

11. The display with nut suspended in midair as claim 10, wherein said holder is a hollow structure.

12. The display with nut suspended in midair as claim 10, further comprising at least one vibration damper fixing said nut to said coupling region so as to reduce the flexibility of said nut.

13. The display with nut suspended in midair as claim 12, wherein said main body, said nut, said holder and said vibration damper are one-body shaped.

14. The display with nut suspended in midair as claim 10, wherein said appearance surface is processed with stoving paint, baking enamel, baking varnish, polish, or other treatments which make said appearance surface present smooth and a bright face.

15. The display with nut suspended in midair as claim 10, wherein said holder includes at least one secondary holder extended from said holder to said nut so as to firmly fix said nut.

16. The display with nut suspended in midair as claim 15, wherein the amount of said secondary holders are pluralities and said secondary holders are disposed surrounding said nut so as to firmly fix said nut.

17. The display with nut suspended in midair as claim 10, wherein said holder further includes at least one first support oriented at a first direction to prevent said nut from swinging at said first direction and at least one second support oriented at a second direction to prevent said nut from swinging at said second direction.

18. The display with nut suspended in midair as claim 17, wherein said first direction and said second direction are orthogonal to each other.
